(19) United States
(12) Patent Application Publication
(10) Pub. No.: US 2005/0121261 A1
(43) Pub. Date: Jun. 9, 2005

(54) Adjustable stepladders and related methods

(76) Inventors: N. Ryan Moss, Mapleton, UT (US); Jack W. Bowers, Springville, UT (US)

Correspondence Address: TRASK BRITT, P.O. BOX 2550, SALT LAKE CITY, UT, 84110, US

(21) Appl. No.: 10/976,443

(22) Filed: Oct. 29, 2004

Related U.S. Application Data
(60) Provisional application No. 60/516,330, filed on Oct. 31, 2003.

(51) Int. Cl. E06C 1/00

(52) U.S. Cl. 182/165

(57) ABSTRACT

An adjustable stepladder is provided including a first set of rails, having a plurality of rungs coupled therebetween, and a second set of rails, also having a plurality of rungs disposed therebetween, slidably coupled with the first set of rails. A single support leg is hingedly coupled with one set of rails and may include a telescoping structure. The support leg may include a base having a plurality of feet wherein the base is integrally formed with a structural member of the support leg. In another embodiment, a removable base may be coupled to a structural member of the support leg such that differently configured bases may be attached to the support leg. The stepladder may, thus be adjustable in terms of height as well as in terms of a support base which will be in contact with the ground or other supporting surface when the ladder is in use.

### CROSS-REFERENCE TO RELATED APPLICATIONS

This application claims the benefit of U.S. Provisional Patent Application Ser. No. 60/516,330, filed Oct. 31, 2003, for ADJUSTABLE STEPLADDERS AND RELATED METHODS, the disclosure of which is incorporated by reference in its entirety.

### BACKGROUND OF THE INVENTION

1. Field of the Invention

The present invention generally relates to ladders and, more particularly, to stepladders which are adjustable in height and with regard to other parameters.

2. State of the Art

Ladders are conventionally used to provide a user thereof with improved access to elevated locations. Ladders come in many sizes and configurations including, for example, straight ladders, extension ladders, stepladders, and combination step and extension ladders. Each type of ladder has it advantages and disadvantages relative to other ladder types. In other words, one ladder may be appropriate for use in performing one task while inappropriate or inadequate for accomplishing another task.

Stepladders are used in many circumstances as a self-supporting structure to provide temporary access to an elevated location. Step ladders conventionally include a first set of rails or legs having a plurality of rungs disposed therebetween, and a second set of rails or legs angularly coupled with the first set of rails such that the vertex of a defined angle therebetween is the general location of coupling between the first set of rails and the second set of rails. The spaced-apart feet of the rails conventionally form a rectangular or square base which, when placed on a stable surface, supports the stepladder by distributing the weight thereof to the four corners of the rectangular or square base. A user may then climb the rungs of the ladder to access a desired location.

While the first and second set of rails of some step ladders may be fixed in position relative to one another such that they maintain their angled configuration, many stepladders include a set of rails which are hinged such that they may collapse against the opposing set of rails to form a more compact structure. While the stepladder is not conventionally utilized to access elevated locations in such a collapsed state, the stepladder may be more easily transported or stored with the sets of rails being collapsed against each other.

As noted above, stepladders are a popular tool because of their versatility in being able to support themselves at virtually any location which provides a stable and relatively flat surface (e.g., the ground or a floor). However, conventional stepladders can be somewhat limited in their use because they are configured to maintain a specified height. Thus, if a given step ladder is too short to reach a desired location or, if it is too tall to fit in a particular area, a separate ladder must be obtained and used.

Additionally, while relatively versatile, stepladders are not particularly suited for use on uneven surfaces, such as on stairs or on a sloped portion of the ground. For example, if the stepladder is supported by a surface such that the feet of the first set of rails are at a substantially different elevation than the feet of the second set of rails, the first set of rails and associated rungs may be oriented at an angle which makes it either awkward or dangerous for a user to climb. Similarly, an uneven support surface may result in each rail of a set of rails being placed at a different elevations resulting in similar challenges and dangers. While, to a certain extent, almost all ladders face similar issues, stepladders are particularly hampered by such a problem because there is a greater likelihood of experiencing a substantial difference among the feet of the stepladder's four rails as compared to, for example, the feet of two rails of a straight ladder or an extension ladder.

A similar difficulty with regard to stepladders includes the lack of an ability to easily and safely position a stepladder in tight locations, corners, around shrubberies and the like. For example, it can be difficult to position a stepladder in a narrow area or in a corner because the rectangular base which is defined by the feet of the rails does not readily accommodate such positioning.

It is also noted that it is an ongoing goal of ladder manufacturers to improve the quality of existing ladders without a substantial increase in the manufacturing cost or, alternatively, to at least maintain the quality of existing ladders while reducing associated manufacturing costs. More specifically, it is an ongoing goal of ladder manufacturers to design and manufacture ladders which provide adequate structural support to a user thereof, and which are also light and simple to transport and store, while maintaining or reducing manufacturing costs of such ladders.

In view of the shortcomings in the art, it would be advantageous to provide an improved stepladder which provides appropriate structural support to a user thereof with a reduction in the weight of the ladder. Additionally, it would be desirable to provide a stepladder which is versatile in its configuration and use such as, for example, with respect to its positioning and placement on a support surface and relative to potential obstructions.

### BRIEF SUMMARY OF THE INVENTION

In accordance with one aspect of the invention a stepladder is provided. The stepladder includes a set of spaced-apart outer rails having a first plurality of rungs coupled therebetween and a set of spaced-apart inner rails having a second plurality of rungs coupled therebetween, wherein the set of inner rails are slidably coupled to the set of outer rails. A single support leg selectively positionable between a first angular position relative to the set of inner rails and at least a second angular position relative to the set of inner rails. A locking mechanism is located and configured to positively lock the single support leg in at least one of the first angular position and the at least a second angular position.

In accordance with another aspect of the invention a stepladder is provided. The stepladder includes a set of spaced-apart outer rails having a first plurality of rungs coupled therebetween and a set of spaced-apart inner rails having a second plurality of rungs coupled therebetween, wherein the set of inner rails are slidably coupled to the set of outer rail. A single support leg is hingedly coupled to the set of inner rails. The single support leg includes a first structural member and a second structural member telescopically coupled with the first structural member. Additionally, the first structural support member includes a single unitary member comprising a columnar section and a base section wherein the base section including at least two legs bent relative to the columnar section.

In accordance with yet another aspect of the present invention, another stepladder is provided. The stepladder includes a set of spaced-apart outer rails having a first plurality of rungs coupled therebetween and a set of spaced-apart inner rails having a second plurality of rungs coupled therebetween, wherein the set of inner rails are slidably coupled to the set of outer rail. A single support leg is hingedly coupled to the set of inner rails. A base is removably coupled with the single support leg. The base may include, for example, a configuration having multiple feet configured for contacting a supporting surface, a single foot configured for contact with a supporting surface, or a spike member configured to penetrate a supporting surface.

In accordance with a further aspect of the present invention a method of forming a ladder is provided. The method includes providing at least one set of spaced apart rails and coupling a plurality of rungs between the at least one set of rails. A single support leg is formed that includes a structural member. The support leg is configured to be selectively positioned between a first angular position relative to the at least one set of spaced apart rails and at least a second angular position relative to the at least one set of spaced apart rails. A locking mechanism is provided to positively and angularly lock the single support leg in at least one of the first angular position and the at least a second angular position.

In accordance with yet a further aspect of the present invention, a method of forming a ladder is provided. The method includes providing at least one set of spaced-apart rails and coupling a plurality of rungs therebetween. A single support leg is formed which includes providing a structural member. A first portion of the structural is defined as a columnar member and a second portion of the structural member is defined as a base. The base is formed by substantially symmetrically dividing the second portion of the structural member along a longitudinal axis to define at least two leg members. The leg members are bent so as to extend away from the first portion of the structural member at an angle relative thereto. The single support leg is hingedly coupled to the at least one set of rails.

In accordance with a further aspect of the present invention, another step ladder is provided. The stepladder includes a set of spaced-apart outer rails having a first plurality of rungs coupled therebetween and a set of spaced-apart inner rails having a second plurality of rungs coupled therebetween, wherein the set of inner rails are slidably coupled to the set of outer rail. A single support leg is hingedly coupled to the set of inner rails. A locking mechanism is operatively coupled with the set of inner rails and the single support leg, wherein the locking mechanism is configured to lock the single support leg from being angularly displaced relative to the to the set of inner rails.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a step ladder in accordance with an embodiment of the present invention;

FIGS. 2A and 2B show a perspective view of a hinge assembly and an elevational view of a hinge member respectively;

FIG. 3 is a side elevational view of the ladder shown in FIG. 1;

FIGS. 4A and 4B show side elevational views of the ladder shown in FIG. 1 at various stages of adjustment;

FIG. 5 shows a support structure for a step ladder in accordance with an embodiment of the present invention;

FIGS. 6A and 6B show cross-sectional views of a support structure as indicated in FIG. 4 according to an embodiment of the present invention;

FIGS. 7A and 7B show cross-sectional views of a support structure as indicated in FIG. 4 in accordance with another embodiment of the present invention;

FIGS. 8A-8C show support structures for a stepladder in accordance with other embodiments of the present invention;

FIGS. 9A and 9B are perspective views of stepladders in accordance with further embodiments of the present invention;

FIG. 10 is a side elevational view of a step ladder in accordance with another embodiment of the present invention; and

FIG. 11 is a partial sectional view of a portion of the ladder depicted in FIG. 10.

### DETAILED DESCRIPTION OF THE INVENTION

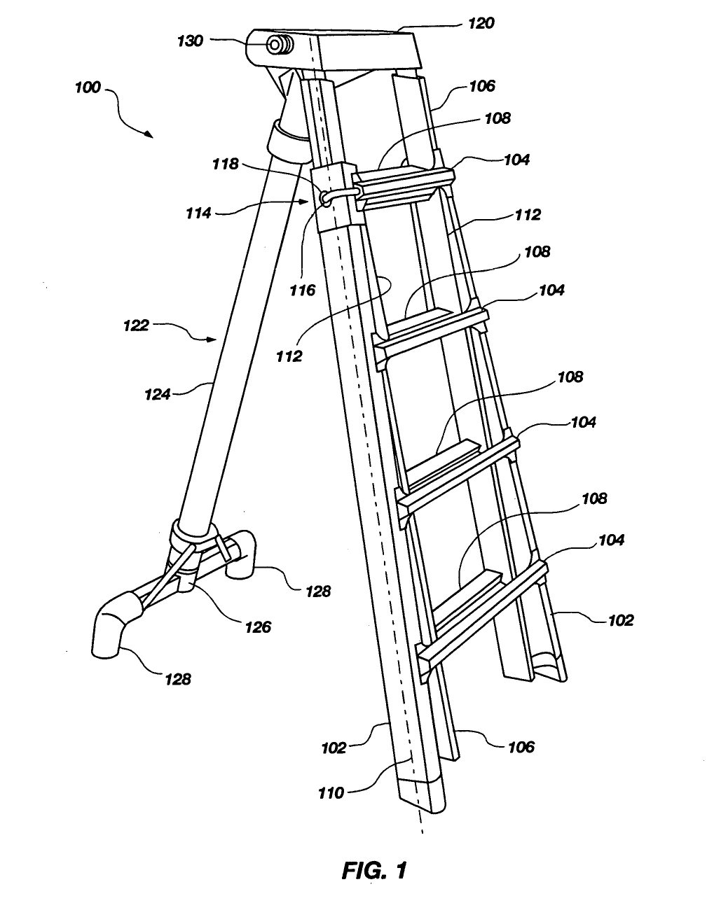

Referring to FIG. 1, an exemplary stepladder 100 is shown in accordance with an embodiment of the present invention. The stepladder 100 includes a set of outer rails 102 having a plurality of rungs 104 (referred to herein as outer rungs for purposes of clarity) spanning a distance between the outer rails 102 and also being coupled to each of the outer rails 102. The stepladder 100 also includes a set of inner rails 106 having a plurality of rungs 108 (referred to herein as inner rungs for purposes of clarity and to distinguish them from the outer rungs 104) spanning a distance between the inner rails 106 and also being coupled to each of the inner rails 106. The outer rungs 104 may be coupled with the outer rails 102, for example, by means of appropriate fasteners, through the use of an adhesive, welding, brazing or through the use of other appropriate techniques known to those of ordinary skill in the art. Similarly, the inner rungs 108 may coupled with the inner rails 106 by any of a variety of appropriate techniques.

The outer and inner rails 102 and 106 and rungs 104 and 108 may be formed of various materials including, but not limited to, metals, metal alloys, plastics, composite materials or combinations thereof. For example, in one embodiment, the inner and outer rails 102 and 106 may be formed of aluminum. Similarly, the rungs 104 and 108 may be formed of aluminum or another appropriate material. In another embodiment, the outer and inner rails 102 and 106, the rungs 104 and 108, or both, may be configured of a composite material such as, for example, fiberglass. Of course, a mixture of materials may also be used such that the outer and inner rails 102 and 106 may be formed of one material while the rungs 104 and 108 may be formed of another material. U.S. Patent Publication No. US-2003-0188923-A1, entitled LIGHT WEIGHT LADDER SYSTEMS AND METHODS, the disclosure of which is incorporated in its entirety herein, describes various means of forming inner and outer rails 102 and 106 and interior and exterior rungs 104 and 108, as well as various means of attaching such rungs 104 and 108 to outer and inner rails 102 and 106, respectively.

Each of the inner rails 106 are disposed adjacent an associated one of the outer rails 102 and are slidable relative thereto. For example, in one embodiment, the outer rails 102 may each be configured as a channel (e.g., exhibiting a substantially C-shaped geometrical cross section as taken transverse to a longitudinal axis 110 thereof). The inner rails 106 may be sized and configured to be received within the interior volume defined by the channel of the outer rails 102 such that the inner rails 106 are slidable relative to the outer rails 102 in a direction along the longitudinal axis 110. In another embodiment a sleeve member 112, which may be configured as a channel-type member, may be coupled to each of the external rails 102 and configured to slidingly receive an internal rail 106 therein.

Exemplary arrangements of inner and outer rail assemblies, including the use of an exemplary sleeve, are disclosed in U.S. Patent Publication No. US-2004-0140156-A1 entitled COMBINATION LADDERS, LADDER COMPONENTS AND METHODS OF MANUFACTURING SAME, the disclosure of which is incorporated by reference in its entirety herein.

A locking mechanism 114 may be used to selectively engage and lock the external rails 102 and internal rails 106 in a desired position relative to one another. The locking mechanism 114 may include, for example, a curved or bent locking pin 116 having one end slidably disposed within an outer rung 104 or otherwise coupled to an outer rail 102. Another end of the locking pin 116 may be slidably disposed within an opening or aperture 118 formed in an outer rail 102 as well as a corresponding opening or aperture (not shown) formed within the inner rail 106. The locking pin 116 may be biased, such as by a spring (not shown), such that it normally remains engaged with both the aperture 118 of the outer rails 102 and the aperture of the inner rail 106. Upon application of an appropriate force, the locking pin 116 may be displaced relative to the outer rung 104, outer rail 102 and inner rail 106 such that it is no longer engaged with the inner rail 106. Upon disengagement of the locking pin 116 from the inner rail 106, the inner rail 106 may be free to slide relative to the outer rail 102. Multiple apertures may be formed in the inner rail 106 in a longitudinally spaced arrangement such that the locking pin 116 may selectively engage any of such apertures and lock the inner rail 106 at a desired position relative to the outer rail 102.

An end of each of the inner rails 106 may be coupled to a platform 120. In one embodiment, the platform 120 may be configured as a tray to hold tools, supplies or other materials thereon such that a user of the stepladder 100 may keep various resources within reach while working at an elevated location on the stepladder 100. A single support leg 122 may also be coupled to the platform 120 and extend therefrom. The single support leg 122, and the various components it may be comprised of, may be formed of various materials including, for example, metals, metal alloys, plastics, composites or combinations thereof.

The single support leg 122 may include a structural member 124 extending from the platform 120 with a base 126 at an end thereof. The base 126 may include a support structure having one or more feet 128 sized, located and configured to support the stepladder 100 when in use. For example, the feet 128 may include two feet spaced apart a desired distance such that, when in use, the stepladder 100 is supported by a traditional rectangular base (i.e., including the feet 128 and the outer rails 102).

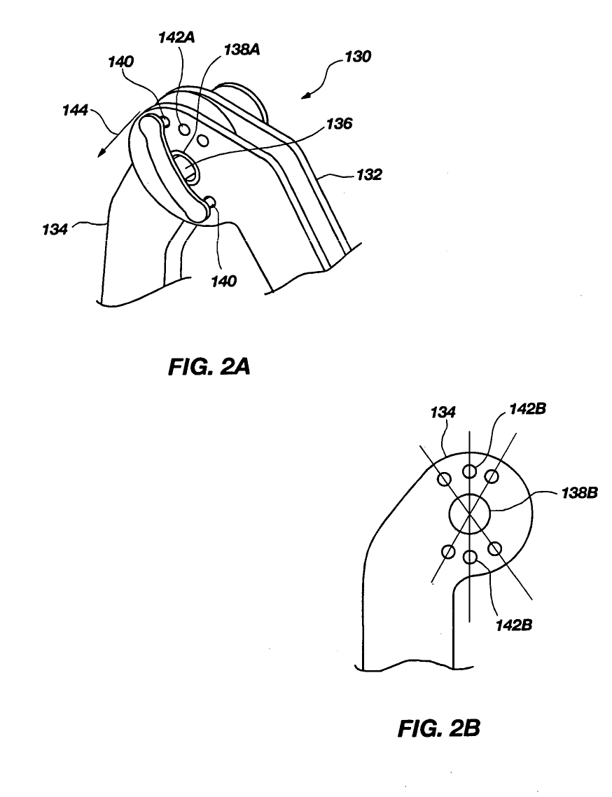

In one exemplary embodiment, the support leg 122 and the inner rails 106 may be rotatable relative to one another about a hinge mechanism 130. The hinge mechanism 130 may include, for example, a locking hinge configured to lock the support leg 122 and inner rails 106 (and, thus the external rails 102) at one or more desired angular positions relative to one another. Referring briefly to FIGS. 2A and 2B, one exemplary embodiment of a hinge mechanism 130 may include a first hinge member 132 coupled with an inner rail 106 and a second hinge member 134 coupled to the support leg 122. The two hinge members 132 and 134 may be coupled by way of a pivot pin 136 which extends through corresponding apertures 138A and 138B formed in the hinge members 132 and 134 respectively.

The hinge mechanism 130 may further include a locking arrangement. The locking arrangement may include one or more locking pins 140 which extend through locking apertures 142A and 142B defined in the hinge members 132 and 134, respectively. For example, the locking pins 140 may be a pair of diametrically opposed pins configured to extend through a first set of diametrically opposed locking apertures in the first hinge member 132 and another set of diametrically opposed locking apertures in the second hinge member 134. It is noted that the hinge might include fewer or more locking pins 140 than shown and described with respect to FIGS. 2A and 2B, or it may include a different type of locking mechanism.

In operation, the pivot pin 136 and associated locking pins 140 of the hinge mechanism 130 may be axially displaced, as indicated by directional arrow 144, such that the locking pins 140 disengage at least the locking apertures 142B of the second hinge member 134 and enable relative rotation of the two hinge members 132 and 134. Upon alignment of a set of locking apertures 142A of the first hinge member 132 along with a set of locking apertures 142B of the second hinge member 134, the locking pins may be axially displaced so as to reengage such locking apertures 142A and 142B to lock the hinge members 132 and 134 at a defined relative angular position and prevent further relative rotation thereof. An exemplary hinge mechanism is shown and described in U.S. Pat. No. 4,697,305, issued to Boothe, the disclosure of which is incorporated by reference in its entirety herein. The use of a locking hinge or similar mechanism enables the support leg 122 to be locked and maintained in a desired angular position relative to the inner rails 106 (and thus the outer rails 102 as well) without use of another structural support member such as, for example, a spreader bar.

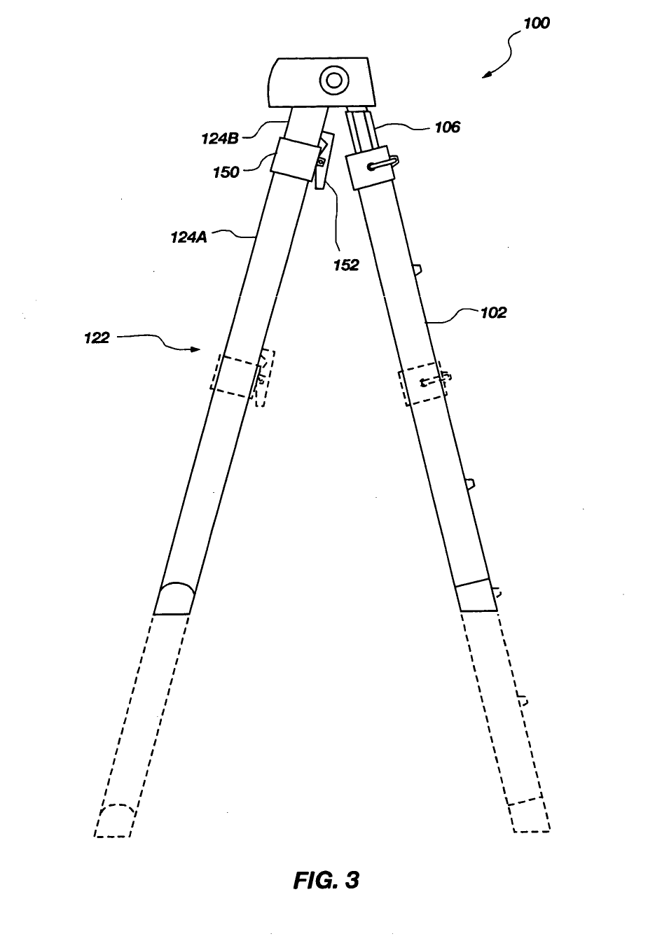

Referring now to FIG. 3, an elevational view of the stepladder 100 is shown, illustrating the adjustability of outer rails 102 relative to the inner rails 106 as well as the adjustability of the support leg 122. As discussed above, the outer rails 102 and inner rails 106 may slide relative to one another along a longitudinal axis 110 as indicated by dashed lines. The support leg 122 may be similarly adjustable. For example, the structural member 124 may include two structural members 124A and 124B which are telescopically coupled to one another. A locking mechanism 150 having an engagement member 152 may be coupled to the first structural member 124A and configured to engage, for example, apertures (not shown in FIG. 3) formed in the second structural member 124B. The telescoping arrangement of the two structural members 124A and 124B, thus, enables the base 126 to be placed in various positions as indicated by dashed lines.

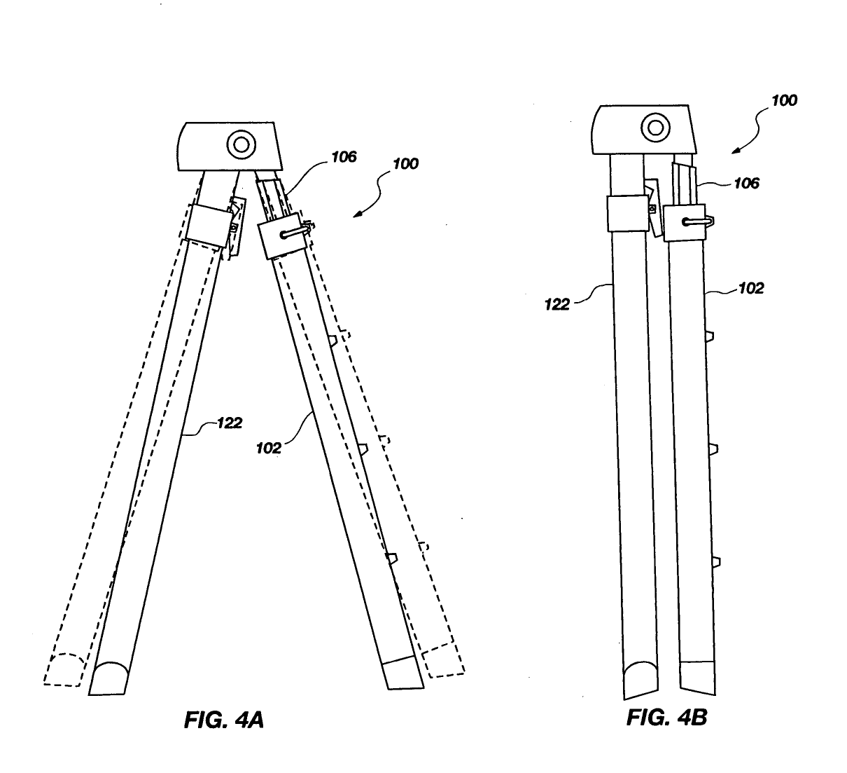

Additionally, referring to FIGS. 4A and 4B, the outer and inner rails 102 and 106 may be placed at various angular positions relative to the support leg 122. For example, as indicated by dashed lines in FIG. 4A, two or more usable positions may be defined by engaging the hinge mechanism 130 with the appropriate locking apertures 142A and 142B (FIGS. 2A and 2B). The angular adjustability of the outer and inner rails 102 and 106 relative to the support leg 122 may enable a user of the stepladder 100 to define, within certain limits, the configuration of the ladder's support base, as may be desired. Additionally, as shown in FIG. 4B, the support leg 122 may be collapsed against the outer and inner rails 102 and 106 such that the stepladder 100 may be more easily stored and transported.

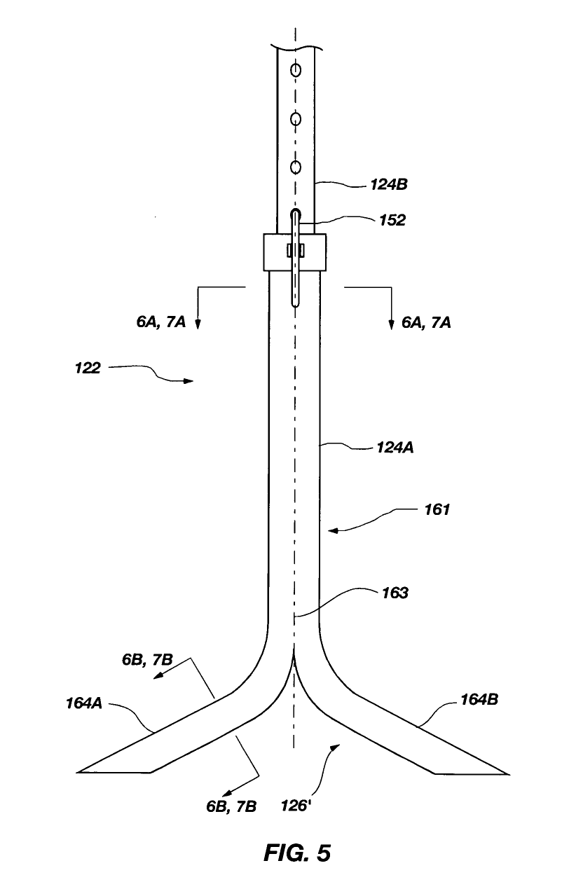

Referring now to FIG. 5, an exemplary support leg 122 is shown in accordance with one embodiment of the present invention. As previously discussed the support leg 122 may include two structural members 124A and 124B which are configured in a telescoping arrangement. Also, a locking mechanism 150 may be coupled to one structural member 124A and include an engagement member 152 configured to selectively engage one of a plurality of apertures 160 formed in the second structural member 124B. Additionally, in one particular embodiment, the first structural member 124A and the base 126′ may be formed as an integral unitary member. Such a structure provides various advantages over multicomponent structures including, for example, a reduction of weight and ease of manufacturing without compromising the structural integrity of the support leg 122 and the stepladder 100.

For example, the first structural member 124A may be defined to include a columnar section 161 and a section including the base 126′. The base 126′ may be formed by substantially symmetrically dividing the first structural member 124A along a longitudinal axis 163 thereof and then bending each longitudinally divided member to form a leg 164A and 164B. The columnar section 161 and the base 126′ are thus formed as an integral unit and may be formed, for example, from a single length of tubing or other material.

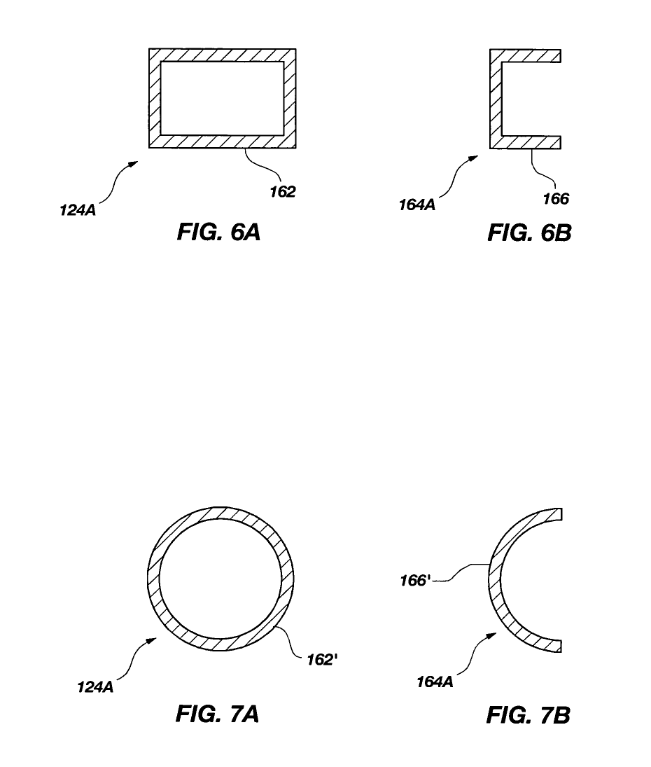

Referring to FIGS. 6A and 6B in conjunction with FIG. 5, in accordance with one embodiment of the present invention, the columnar section 161 may exhibit a cross-sectional geometry of a substantially square or rectangular tube 162. As noted above, the base 126′ may include two legs 164A and 164B which are substantially symmetrically divided and bent relative to the columnar section 161 of the structural member 124A. Thus, the legs 164A and 164B may exhibit a cross-sectional geometry of a structural channel or a C-shape 166 as indicated in FIG. 6B. Of course the components may exhibit other appropriate geometrical cross sections. For example, as shown in FIGS. 7A and 7B, the columnar section 161 may exhibit a substantially circular cross section, and the legs 164A and 164B may exhibit a cross section which is substantially half of a circle. It is noted that the support leg 122 may be formed of various materials including those set forth above with regard to the support leg. In one exemplary embodiment the first structural member 124A may be formed of aluminum tubing.

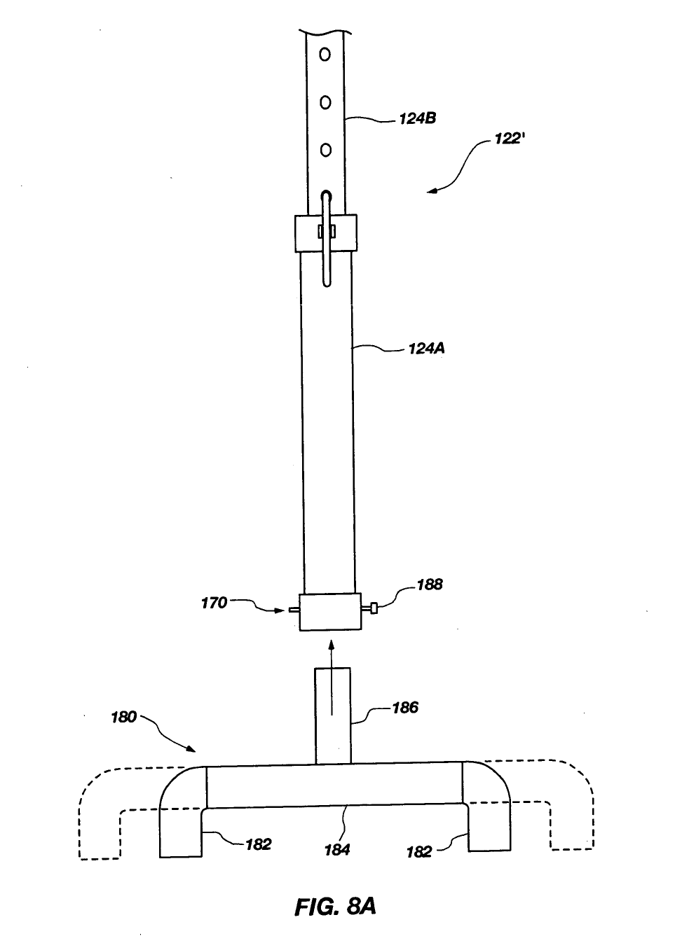

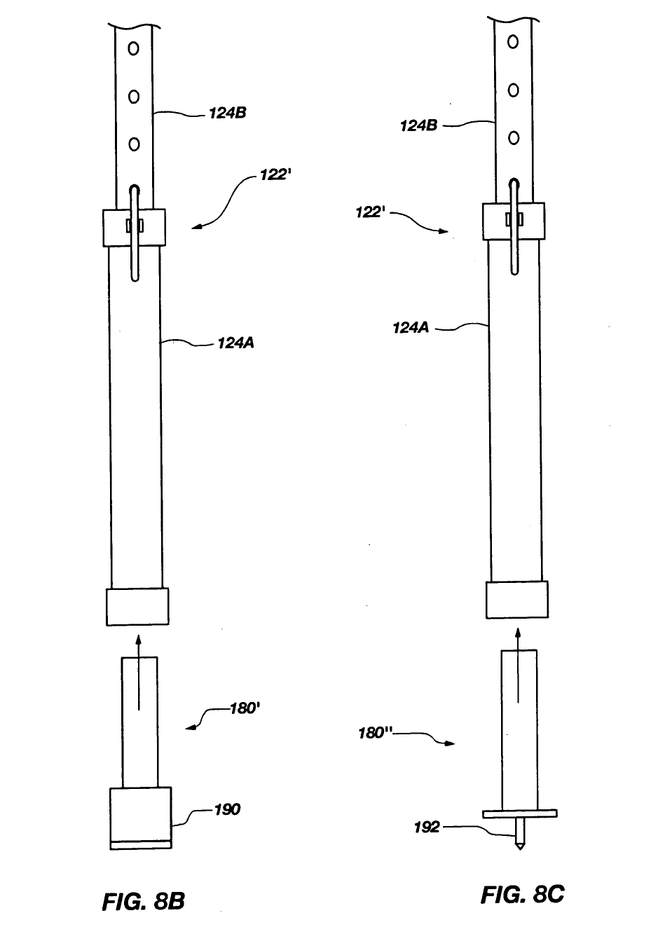

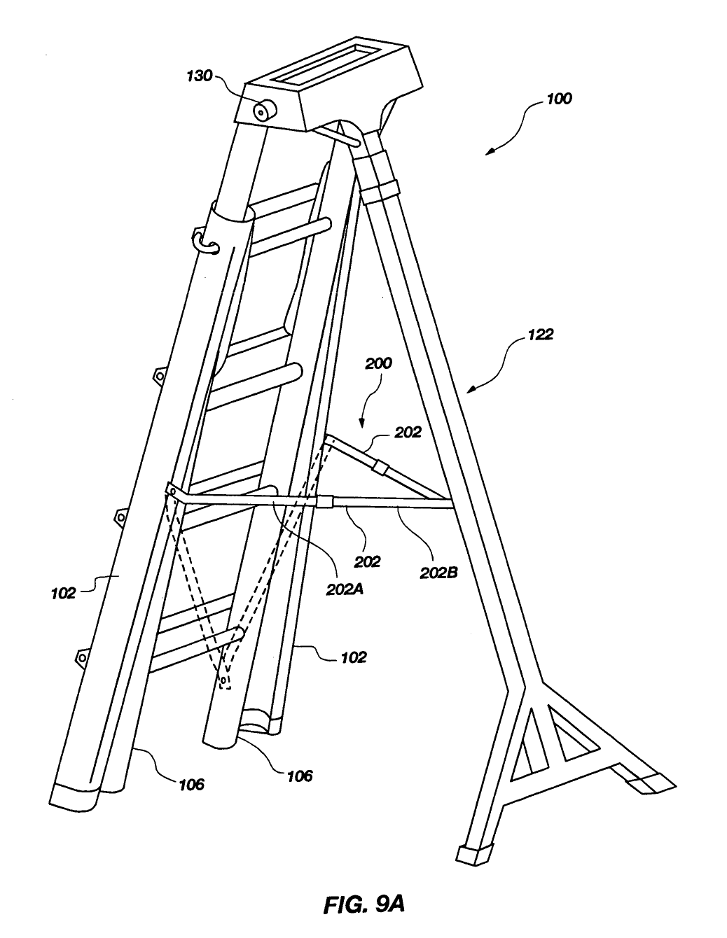

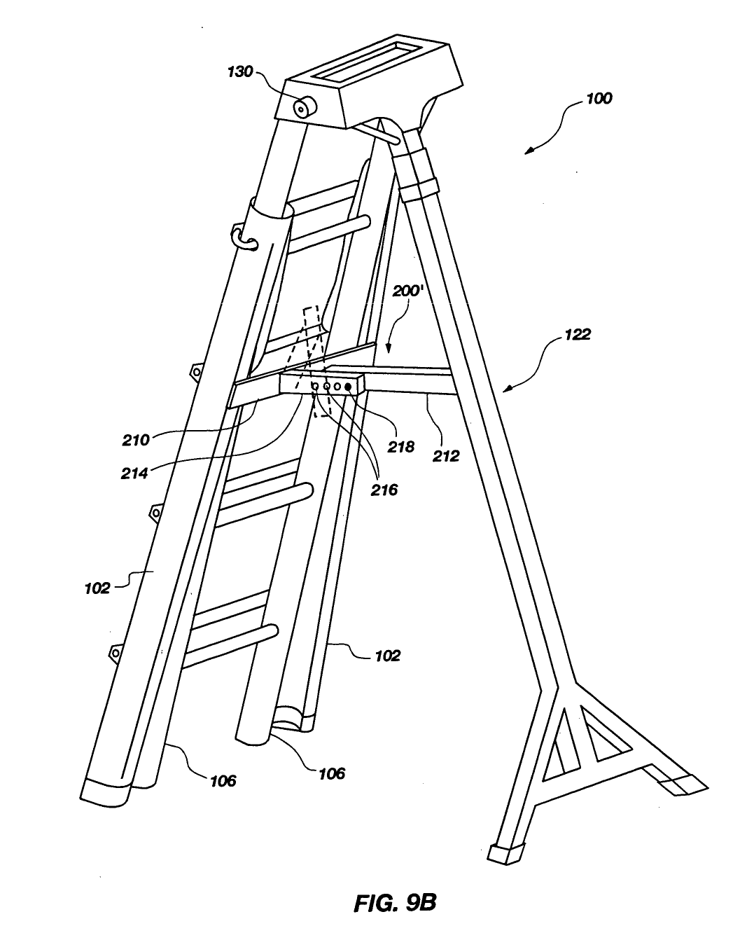

Referring now to FIGS. 8A through 8C, a support leg 122′ in accordance with another embodiment of the present invention is shown. The support leg 122′ may include a coupling assembly 170 at an end of the first structural member 124A. The coupling assembly 170 may be configured to selectively couple the structural member 124A to a removable base 180. The removable base 180 may include a pair of feet 182 coupled to a cross member 184. A coupling stem 186 may be extend from the cross member 184 and be configured for removable coupling with the structural member 124A.

The coupling assembly 170 may include, for example, one or more locking pins 188 configured to engage one or more apertures defined in the structural member 124A and corresponding apertures in the coupling stem 186 (apertures not shown). Other coupling devices may also be used as will be appreciated by those of ordinary skill in the art.

The cross member 184 of the removable base may also be adjustable such that the feet 182 coupled therewith may be laterally adjusted relative to the coupling stem 186 as indicated by dashed lines. Thus, the feet may be placed at a desired width to form a supporting base for the stepladder depending on particular circumstances and conditions of use.

The removable base 180 of FIG. 8A may be removed and replaced with a differently configured base. For example, referring to FIG. 8B a base 180′ may include a single foot 190, thus, effectively turning the stepladder 100 into a tripod or orchard ladder. Referring to FIG. 8C, another base 180″ may include a spiked foot 192 configured to be staked into the ground or other supporting surface. Thus, the modular nature of the removable bases 180, 180′, 180″ provides considerable flexibility in the use of the stepladder 100 in terms of locations and situations in which the ladder may be effectively used.

Turning now to FIGS. 9A and 9B, additional embodiments of the stepladder 100 are shown wherein locking mechanisms are provided to lock the outer and inner sets of rails 102 and 106 relative to the single support leg 122 at a desired angular position. It is noted that the previously described embodiments associated with FIGS. 1-5 have been discussed in terms of an exemplary hinge and locking mechanism which positively locks the outer and inner rails 102 and 106 relative to the single support leg 122 without the need of an additional locking mechanism or structural support member. FIGS. 9A and 9B show other exemplary embodiments of a locking feature which might be used in conjunction with, or in lieu of, other locking mechanism disclosed herein.

For example, FIG. 9A shows a first locking spreader mechanism 200 which includes a first spreader bar 202 coupled with an outer rail 102 and a second spreader 204 coupled to the opposing outer rail 102. The spreader bars 202 and 204 may, for example, be hingedly coupled to the outer rails such that they may be displaced from a first position to a second position (the second position be indicated by dashed lines). In the first position, the spreader bars 202 and 204 may form a triangular structural arrangement by being coupled to the single support leg 122. Upon being coupled to the single support leg 122, the locking spreader arrangement 200 acts to prevent the angular displacement of the single support leg 122 about the hinge mechanism 130 in either direction relative to the outer and inner rails 102 and 106. Such a configuration is an advantage over, for example, so-called orchard ladders which do not include spreader bars or other locking arrangements.

It is noted that the locking spreader mechanism 200 may include additional features if so desired. For example, the spreader bars 202 and 204 may include individual telescoping sections (e.g., 202A and 202B) such that they may extend and accommodate different spreader distances depending on whether the ladder has been adjusted for height (e.g., see FIG. 3 and attendant discussion thereof). Additionally, ball joints or universal joints may be used in coupling the spread bars 202 and 204 to the outer rails 102, to the single support leg 122 or both. Also, in another configuration, the spreader bars 202 and 204 may be coupled with the inner rails 106 rather than the outer rails 102.

Referring to FIG. 9B, another exemplary configuration of a locking spreader mechanism 200′ is shown. The locking spreader mechanism 200′ may include a structural cross member 210 coupled to, for example, the outer rails 102. A spreader bar 212 may be coupled between the single support leg 122 and the structural cross member 210 in a “T” configuration. In one particular embodiment, one or more structural members 214 may be selectively engageable with the spreader bar 212 at multiple positions so as to define a span or distance between the outer and inners rails 102 and 106 and the single support leg 122. For example, one or more apertures (not shown) may be formed in the spreader bar 212 for alignment with one or more apertures 216 formed in the structural members 214. A pin 218 may be inserted through aligned apertures to lock the spreader bar 212 in a desired position relative to the structural members 214.

In another embodiment, the structural members 216 may be hingedly coupled with the structural cross members 210, the spreader bar 212 may be hingedly coupled to the support leg 122 with the pin 218 acting as a pivot point such that the locking spreader mechanism 200′ is collapsible, as shown generally in dashed lines, upon rotation of the single support leg 122 about the hinge mechanism 130 relative to the outer and inner rails 102 and 106. Other features, such as described with respect to FIG. 9A, may also be incorporated with the locking spreader mechanism 200′.

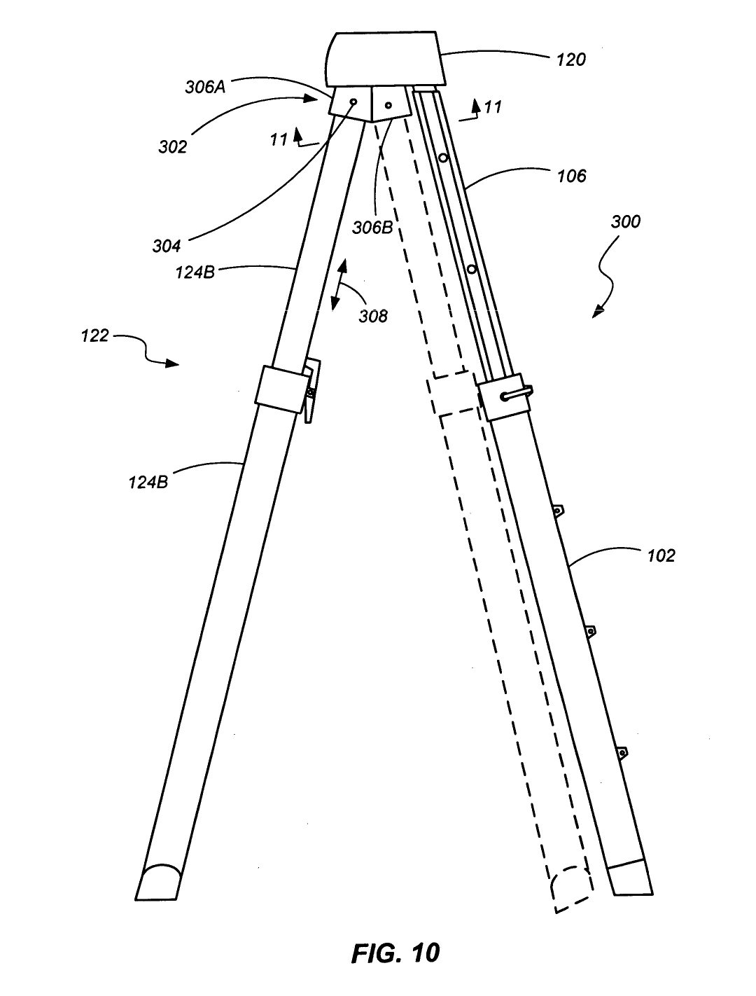

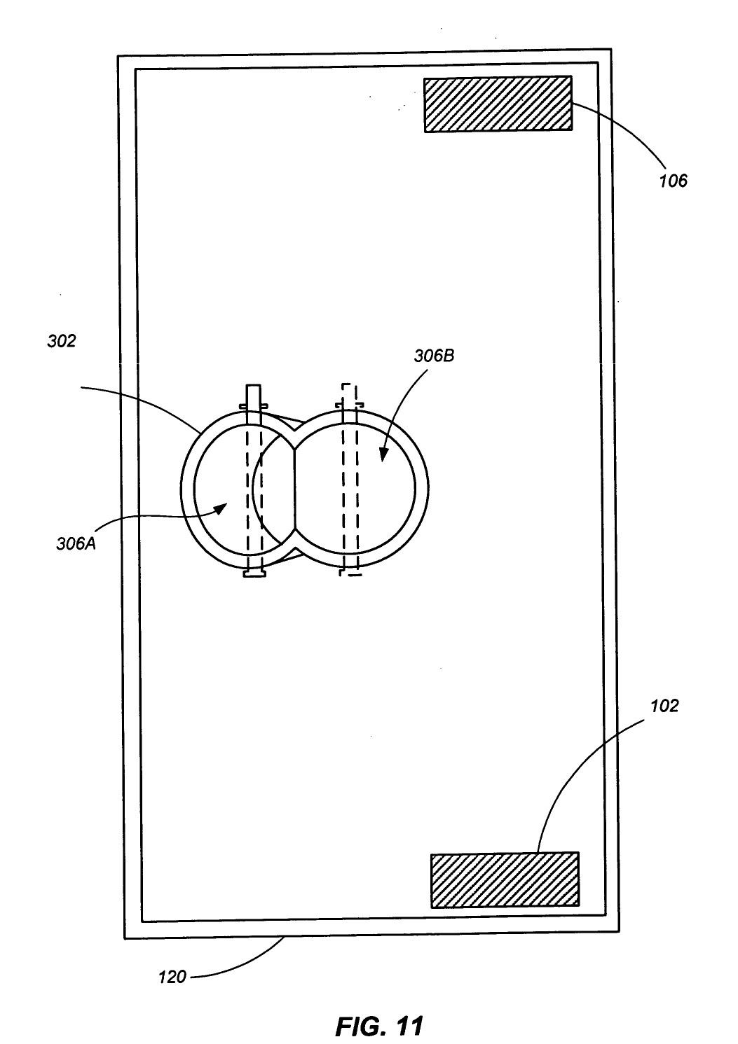

Referring now to FIGS. 10 and 11, a ladder 300 is shown in accordance with another embodiment of the present invention. The ladder 300 includes outer and inner rails 102 and 106 such as described hereinabove with respect to other embodiments. The ladder also includes a single support leg 122 such as described hereinabove. In one embodiment, a coupling structure 302 may be integrally formed with, or otherwise coupled with the platform 120. The coupling structure 302 is sized and configured to matingly receive an end of the support leg 122 and, more particularly, an end of the second structural member 124B. The coupling structure 302 may include a locking pin 304 or other structure or mechanism configured to maintain the support leg 122 in a coupled relationship therewith. As such, the coupling structure 302 acts like a locking mechanism to positively lock the support leg 122 one or more angular positions relative to the outer and inner rails 102 and 106.

In one exemplary embodiment, the coupling structure 302 may be configured to enable selective positioning of the support leg 122 relative to the outer and inner rails 102 and 106. For example, as shown in FIG. 11, the coupling structure may be configured to include a first coupling sleeve 306A and a second coupling sleeve 306B. Thus, as indicated in FIG. 10 by directional arrow 308, the support leg 122 may be removed from the first coupling sleeve 306A of the coupling structure 302 and then inserted in the second sleeve 306B of the coupling structure 302 (as shown in dashed lines). The sleeves 306A and 306A may be configured to exhibit a similar cross-sectional geometry as that of the support leg 122. Thus, for example, the sleeves 306A and 306B may exhibit a generally circular cross-sectional geometry so as to cooperatively and matingly receive a support leg 122 also exhibiting a substantially circular cross-sectional geometry (or at least the end of the support leg which is inserted into or otherwise engages the sleeves 306A and 306B). Of course, the sleeves 306A and 306B and support leg 122 may exhibit other cross-sectional geometries including, for example, oval, rectangular, square, or other polygonal geometries.

The locking pin 304 or other mechanism may be operated to maintain the support leg 122 in either coupling sleeve 306A or 306B. Such a structure again enables the support leg to be selectively maintained between multiple positions with or without other structural support mechanisms such as, for example, spreader bars. It will be appreciated by those of skill in the art that the coupling structure 302 may be configured to maintain the support leg 122 in multiple positions other than those depicted in FIGS. 10 and 11. Thus, for example, the coupling structure may be configured to selectively maintain the support leg 122 in three or in four positions instead of two. Additionally, instead of having a coupling structure 302 with multiple sleeves 306A and 306A, the coupling structure 302 may include a structural plate positioned on each lateral side of the support leg 122 with multiple locking pins 304 extending through the plates and the support leg 122.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

1. A stepladder comprising:
a set of spaced-apart outer rails having a first plurality of rungs coupled therebetween;
a set of spaced-apart inner rails having a second plurality of rungs coupled therebetween, the set of inner rails being slidably coupled to the set of outer rails;
a single support leg selectively positionable between a first angular position relative to the set of inner rails and at least a second angular position relative to the set of inner rails; and
a locking mechanism located and configured to positively lock the single support leg in at least one of the first angular position and the at least a second angular position.

2. The stepladder of claim 1, wherein the locking mechanism is configured to lock the single support leg in each of the first angular position and the at least a second angular position.

3. The stepladder of claim 1, wherein the single support leg further includes a first structural member and a second structural member telescopically coupled with the first structural member and, wherein the first structural member includes a single unitary member comprising a columnar section and a base section, the base section including at least two legs bent relative to the columnar section.

4. The stepladder of claim 1, further comprising a hinge member coupled to the single support leg and configured to accommodate angular displacement of the single support leg between the first angular position and the at least a second angular position.

5. The stepladder of claim 3, wherein the columnar section exhibits a substantially rectangular cross-sectional geometry as taken transverse to a length thereof, and wherein each of the at least two legs of the base section exhibits a substantially C-shaped cross-sectional geometry as taken transverse to a respective length of each leg.

6. The stepladder of claim 3, further comprising a locking mechanism configured to selectively lock the single support leg at a desired angular position relative to the inner rails.

7. The stepladder of claim 3, wherein the single support leg is formed of a material comprising aluminum.

8. The stepladder of claim 3, wherein the set of outer rails and the set of inner rails are formed of a material comprising fiberglass.

9. The stepladder of claim 3, wherein the set of outer rails and the set of inner rails are formed of a material comprising aluminum.

10. The stepladder of claim 1, further comprising a base removably coupled with single support leg.

11. The stepladder of claim 10, wherein the base comprises:
a coupling stem removably coupled with the single support leg;
a cross member coupled with the coupling stem; and
a pair of feet coupled to the cross member.

12. The stepladder of claim 11, wherein the cross member is extendable such that each foot of the pair of feet are adjustable between a first distance relative to the coupling stem, and a second distance relative to the coupling stem.

13. The stepladder of claim 10, wherein the base comprises a single foot removably coupled with the single support leg.

14. The stepladder of claim 10, wherein the base comprises at least one foot having at least one spike coupled therewith, the at least one spike being oriented and configured to penetrate a supporting surface on which the stepladder is placed.

15. A method of forming a ladder, the method comprising:
providing at least one set of spaced-apart rails;
coupling a plurality of rungs between the at least one set of rails;
forming a single support leg including providing a structural member;
configuring the single support leg to be selectively positioned between a first angular position relative to the at least one set of spaced-apart rails and at least a second angular position relative to the at least one set of spaced-apart rails; and
providing a locking mechanism to positively and angularly lock the single support leg in at least one of the first angular position and the at least a second angular position.

16. The method according to claim 15, wherein providing a locking mechanism further comprises configuring the locking mechanism to angularly lock the single support leg in each of the first angular position and the at least a second angular position.

17. The method according to claim 15, further comprising:
defining a first portion of the structural member as a columnar member and second portion of the structural member as a base;
forming the base of the structural member including substantially symmetrically dividing the second portion of the structural member along a longitudinal axis to define at least two leg members and, bending each of the at least two leg members to extend away from the first portion of the structural member at an angle relative thereto; and
hingedly coupling the single support leg to the at least one set of rails.

18. The method according to claim 17, further comprising forming the columnar member to exhibit a substantially rectangular cross-sectional geometry as taken transverse to a longitudinal axis thereof.

19. The method according to claim 17, further comprising forming the columnar member to exhibit a substantially circular cross-sectional geometry as taken transverse to a longitudinal axis thereof.

20. The method according to claim 15, wherein forming a single support leg further includes telescopically coupling the structural member to another structural member.

21. The method according to claim 15, further comprising configuring the single support leg to pivot about a hinge between the first angular position and the at least a second angular position.

22. The method according to claim 15, wherein providing at least one set of spaced-apart rails includes providing a set of outer rails, a set of inner rails and slidably coupling the set of inner rails to the set of outer rails.

23. The method according to claim 22, further comprising providing a platform adjacent a location of hinge.

24. The method according to claim 15, further comprising forming the single support leg to include a removable base.

25. The method according to claim 24, further comprising forming the removable base to include a pair of feet.

26. The method according to claim 24, further comprising forming the removable base to include a single foot.

27. The method according to claim 24, further comprising forming the removable base to include at least one spike coupled therewith, and configuring and orienting the at least one spike to penetrate a supporting surface on which the ladder is placed.
